(19) United States
(12) Patent Application Publication
(10) Pub. No.: US 2022/0049520 A1
(43) Pub. Date: Feb. 17, 2022

(54) HYBRID TOWER SECTION, HYBRID TOWER FOR A WIND POWER PLANT AND METHOD OF PRODUCTION

(71) Applicant: Wobben Properties GmbH, Aurich (DE)

(72) Inventor: Norbert HÖLSCHER, Aurich (DE)

(21) Appl. No.: 17/429,894

(22) PCT Filed: Feb. 10, 2020
(86) PCT No.: PCT/EP2020/053361

§ 371 Date: Aug. 10, 2021

(30) Foreign Application Priority Data
Feb. 13, 2019 (DE) 10 2019 103 589.9

(51) Int. Cl. E04H 12/08; F03D 13/20; E04H 12/12; E04H 12/34

(52) U.S. Cl. CPC E04H 12/085; F03D 13/20; E04H 12/12; E04H 12/16; F05B 2230/50; F05B 2240/912; E04H 12/342

(57) ABSTRACT

A hybrid tower section for arrangement between a concrete tower section and a steel tower section of a hybrid tower for a wind power installation. The hybrid tower section comprises a steel flange having a multiplicity of annularly arranged blind holes and having a multiplicity of annularly arranged passage holes, a steel outer casing, and a concrete core, wherein the annular arrangement of the blind holes has a larger radius than the annular arrangement of the passage holes, wherein the steel outer casing has a larger radius than the annular arrangement of the blind holes, wherein the concrete core adjoins the steel flange and the steel outer casing, and a radially inner side of the concrete core has a larger radius than the annular arrangement of the passage holes.

### BACKGROUND

### Technical Field

The invention relates to a hybrid tower section for arrangement between a concrete tower section and a steel tower section of a hybrid tower for a wind power installation. The invention furthermore relates to a hybrid tower for a wind power installation, to a wind power installation, to a method for producing a hybrid tower section, and to a method for producing a hybrid tower for a wind power installation.

### Description of the Related Art

It is known for wind power installations to use hybrid towers. A hybrid tower generally refers to a tower which comprises a concrete tower section and a steel tower section. Normally, the concrete tower section is a tower section which is at the bottom in the operating state of the wind power installation, whereas the steel tower section is a tower section which is at the top in the operating state of the wind power installation. A challenge with hybrid towers for wind power installations is presented by the transition from the concrete tower section to the steel tower section.

The German Patent and Trademark Office has searched the following prior art in the priority application relating to the present application: DE 10 2010 039 796 A1, DE 10 2016 114 114 A1, DE 10 2016 125 062 A1, DE 10 2013 211 750 A1.

### BRIEF SUMMARY

Provided is a hybrid tower section, a hybrid tower, a wind power installation, a method for producing a hybrid tower section, and a method for producing a hybrid tower that are improved in relation to existing solutions. Provided is a hybrid tower section, a hybrid tower, a wind power installation, a method for producing a hybrid tower section, and a method for producing a hybrid tower that allow a cost-effective and reliable solution for the transition from a concrete tower section to a steel tower section.

Provided is a hybrid tower section for arrangement between a concrete tower section and a steel tower section of a hybrid tower for a wind power installation, the hybrid tower section comprising: a steel flange having a multiplicity of annularly arranged blind holes and having a multiplicity of annularly arranged passage holes, a steel outer casing, and a concrete core, wherein the annular arrangement of the blind holes has a larger radius than the annular arrangement of the passage holes, wherein the steel outer casing has a larger radius than the annular arrangement of the blind holes, wherein the concrete core adjoins the steel flange and the steel outer casing, and a radially inner side of the concrete core has a larger radius than the annular arrangement of the passage holes.

The hybrid tower section also serves in particular for fastening of tensioning members at the end thereof that is at the top in the operating state. Such tensioning members are generally used for prestressing a concrete tower section, wherein the tensioning members are fastened to an upper end of the concrete tower section and to a lower end of the concrete tower section or to a foundation of the tower. In particular, such tensioning members may be arranged and fastened in the annularly arranged passage holes of the steel flange of the hybrid tower section. The steel flange additionally has a multiplicity of annularly arranged blind holes. Said annularly arranged blind holes may serve in particular for receiving fastening elements, such as for example threaded bolts, which connect the steel flange of the hybrid tower section to a steel tower section, in particular to a lower end thereof.

The annular arrangement of the blind holes has a larger radius than the annular arrangement of the passage holes. Since the passage holes preferably serve for receiving tensioning members, and these external tensioning members preferably run in an interior of the hybrid tower, it is preferable for the multiplicity of annularly arranged blind holes to be situated radially outside the multiplicity of annularly arranged passage holes.

The hybrid tower section furthermore has a steel outer casing. The steel outer casing preferably extends downward from a side of the steel flange that is at the bottom in the operating state. The steel outer casing is preferably arranged and/or configured to form an outer wall of the hybrid tower and/or to align with an outer wall of a concrete tower section and/or of a steel tower section.

The steel outer casing has a larger radius than the annular arrangement of the blind holes. This arrangement is particularly preferred if the steel outer casing forms a part of the outer wall of the hybrid tower.

The hybrid tower section furthermore has a concrete core. The concrete core adjoins both the steel flange, in particular a side of the steel flange that is at the bottom in the operating state, and the steel outer casing, in particular a radially inner side of the steel outer casing. A radially inner side of the concrete core has a larger radius than the annular arrangement of the passage holes. This is in particular preferable since the passage holes, as described, serve in particular for arrangement and fastening of tensioning members for prestressing the concrete tower section. In order for the tensioning members to be able to run in the interior of the hybrid tower without hindrance, it is preferable for a radially inner side of the concrete core to have a larger radius than the annular arrangement of the passage holes and consequently to extend radially outside the passage holes.

The hybrid tower section described here has various advantages. The combination of the materials steel and concrete can give rise to a weight which is favorable in comparison with existing solutions. The hybrid tower section described here has a lower weight in particular in comparison with transition tower sections which are formed substantially or completely from steel. A further advantage arises in that, as a result of the concrete core, which is preferably situated at the bottom in the operating state, an abutment connection between the concrete tower section and the hybrid tower section can advantageously use the coefficient of friction for concrete on concrete. For example, for the concrete tower section, multiple annular concrete tower portions are placed one on top of the other, wherein said concrete tower portions placed one on top of the other are generally connected to one another solely via an abutment connection, without additional connecting means, such as for example epoxy resin, or other connecting elements. As a result of the prestressing of the concrete tower section via the tensioning members, the abutment connections are subjected to pressure and thus form a reliable connection.

The steel flange and/or the steel outer casing and/or the concrete core are/is preferably arranged and/or configured to introduce in particular the forces and moments originating from the pretensioned tensioning members reliably into a concrete tower section which is situated at the top in the operating state.

During the production of the concrete core, the hybrid tower section, in comparison with its installed state, is preferably arranged in a manner reflected with respect to a horizontal plane. In this arrangement, the steel outer casing preferably projects upward. Preferably, the steel outer casing serves as a permanent formwork during the concreting of the concrete core.

A further preferred embodiment comprises a steel inner casing, wherein the steel inner casing has a radius which is larger than the radius of the annular arrangement of the passage holes and is smaller than the radius of the annular arrangement of the blind holes.

Preferably, beside the steel outer casing, the hybrid tower section also has a steel inner casing. The steel inner casing, too, has a larger radius than the annular arrangement of the passage holes, in order that the suitability of the latter for receiving tensioning members is not adversely affected.

According to a further preferred embodiment, it is provided that a radially inner side of the steel outer casing and/or a radially outer side of the steel inner casing have/has a contoured surface and/or one, two or more projections and/or depressions and/or shear cleats.

The projections and/or depressions and/or shear cleats and/or the contoured surface preferably protrude(s) in a radial direction from the radially inner side of the steel outer casing and/or from the radially outer side of the steel inner casing, for example into an intermediate space formed between the steel outer casing and the steel inner casing. A contoured surface may for example be of tooth cut-type form, in particular in a longitudinal section along a longitudinal axis of the tower.

The provision of a contoured surface and/or of one, two or more projections and/or depressions and/or shear cleats at the steel outer casing and/or at the steel inner casing has the advantage in particular that through these/this a transmission of force between the steel outer casing and/or the steel inner casing and the concrete core is improved.

The provision of both a steel outer casing and of a steel inner casing has the advantage inter alia that both the steel outer casing and the steel inner casing can be used as a permanent formwork for the production of the concrete core. Preferably, during the production of the concrete core, the hybrid tower section, in comparison with its operating state, is arranged in a manner reflected with respect to a horizontal plane. Preferably, in this production position of the hybrid tower section, the steel outer casing and/or the steel inner casing project(s) upward from the steel flange. In this way, flowable concrete can be introduced into the intermediate space between the steel outer casing and the steel inner casing and cure there.

In a preferred embodiment, it is provided that the steel outer casing and/or the steel inner casing and/or the concrete core have/has an axial height which is several times larger than an axial height of the steel flange. It is furthermore preferred that the steel outer casing and/or the steel inner casing and/or the concrete core have/has an axial height of 1-2 m (meters). It may furthermore be preferred that the steel outer casing and/or the steel inner casing and/or the concrete core have/has a radial thickness of 1-20 cm (centimeters).

It is furthermore particularly preferred that the concrete core directly adjoins the steel outer casing, in particular directly adjoins the radially inner side of the steel outer casing. In a preferred embodiment, it is provided that the concrete core directly adjoins the steel inner casing, in particular directly adjoins the radially outer side of the steel inner casing. Furthermore, it is preferred that the concrete core directly adjoins the steel flange, in particular directly adjoins a side of the steel flange that is at the bottom in the operating state of the hybrid tower. In a further preferred embodiment, it is provided that the concrete core comprises reinforcement. In particular, it is preferred that the concrete core terminates in alignment with an axial end of the steel outer casing and/or in alignment with an axial end of the steel inner casing.

In particular, it is preferably provided that the concrete core substantially completely fills a space between the steel outer casing and the steel inner casing.

According to a further preferred embodiment, it is provided that the steel outer casing and/or the steel inner casing are/is formed in one piece with the steel flange. It may furthermore be preferred that the steel outer casing and/or the steel inner casing are/is welded to the steel flange.

A one-piece formation is to be understood here as meaning in particular the simultaneous production of the steel outer casing and/or the steel inner casing with the steel flange, for example in a primary forming process. It is furthermore preferably possible for the steel outer casing and/or the steel inner casing to be connected to the steel flange, for example in a materially bonded and/or form-fitting and/or force-fitting manner. In particular, a form-fitting connection in the form of a weld is preferred.

Further advantageous embodiment variants of the apparatus described above are obtained by combining the preferred features discussed here.

According to a further aspect of the invention, provided is a hybrid tower for a wind power installation, comprising at least one concrete tower section and one steel tower section, wherein a hybrid tower section described above is arranged between the concrete tower section and the steel tower section.

According to a further aspect of the invention, provided is a wind power installation having a hybrid tower section described above and/or having a hybrid tower described above.

According to a further aspect of the invention, provided is a method for arrangement between a concrete tower section and a steel tower section of a hybrid tower for a wind power installation by providing a steel flange having a plurality of annularly arranged blind holes and having a multiplicity of annularly arranged passage holes, wherein the annular arrangement of the blind holes has a larger radius than the annular arrangement of the passage holes, wherein the steel outer casing has a larger radius than the annular arrangement of the blind holes, providing a steel outer casing, arranging the steel flange and the steel outer casing in such a way that a side of the steel flange that is at the bottom in the operating state of a hybrid tower faces upward and the steel outer casing projects upward from that side of the steel flange which is at the bottom in the operating state of a hybrid tower, making the concrete core using the steel outer casing as a formwork in such a way that the concrete core adjoins the steel flange and the steel outer casing and a radially inner side of the concrete core has a larger radius than the annular arrangement of the passage holes.

The above-described method can be developed by the following steps: providing a steel inner casing, and preferably arranging the steel inner casing in such a way that the steel inner casing projects upward from that side of the steel flange which is at the bottom in the operating state of a hybrid tower, and/or welding the steel outer casing and/or the steel inner casing to the steel flange, and/or introducing reinforcement prior to making the concrete core, and/or making the concrete core using the steel inner casing as a formwork.

According to a further aspect of the invention, provided is a method for producing a hybrid tower for a wind power installation, the method comprising: providing at least one concrete tower section, arranging a hybrid tower section described above on the concrete tower section, arranging a steel tower section on the hybrid tower section.

The above-described method can be developed by the following steps: fastening the steel tower section to the hybrid tower section by means of the plurality of annularly arranged blind holes, and/or fastening tensioning members at the plurality of annularly arranged passage holes and preferably tensioning the tensioning members.

This method described above and its possible developments have features or method steps that make them particularly suitable for being used for a hybrid tower section according to the invention and its developments.

With regard to the advantages, embodiment variants and embodiment details of said further aspects of the invention and the developments thereof, reference is made to the preceding description in relation to the corresponding apparatus features.

### BRIEF DESCRIPTION OF THE SEVERAL VIEWS OF THE DRAWINGS

Preferred exemplary embodiments will be described by way of example on the basis of the appended figures. In the figures:

FIG. 1 shows a schematic illustration of a wind power installation;

FIG. 2 shows a schematic illustration of a detail of a longitudinally sectioned, three-dimensional view of an exemplary embodiment of a hybrid tower section;

FIG. 3 shows a schematic cross-sectional view, not to scale, of an exemplary embodiment of a hybrid tower sectioned through a hybrid tower section, with a schematic indication of various radii;

FIG. 4 shows a schematic sequence of an exemplary embodiment of a method for producing a hybrid tower section;

FIG. 5 shows a schematic sequence of an exemplary embodiment of a method for producing a hybrid tower for a wind power installation.

In the figures, identical or substantially functionally identical elements are denoted by the same reference signs. General descriptions relate as a rule to all the embodiments, unless differences are explicitly indicated.

### DETAILED DESCRIPTION

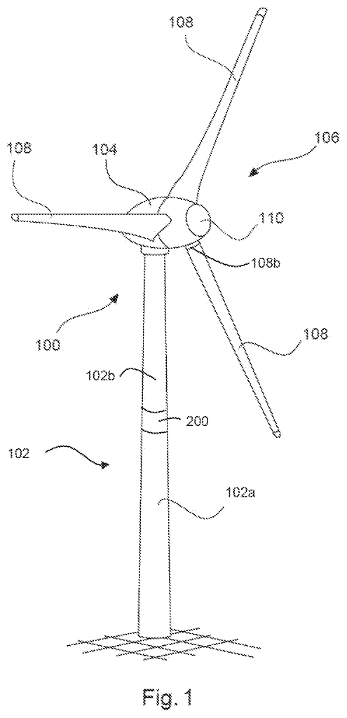

FIG. 1 shows a schematic illustration of a wind power installation according to the invention. The wind power installation 100 has a tower 102 and a nacelle 104 on the tower 102. An aerodynamic rotor 106 having three rotor blades 108 and having a spinner 110 is provided on the nacelle 104. During the operation of the wind power installation, the aerodynamic rotor 106 is set in rotational motion by the wind and thereby also rotates an electrodynamic rotor or runner of a generator, which is coupled directly or indirectly to the aerodynamic rotor 106. The electric generator is arranged in the nacelle 104 and generates electrical energy. The pitch angles of the rotor blades 108 can be changed by pitch motors at the rotor blade roots 108b of the respective rotor blades 108.

The tower 102 is designed as a hybrid tower with a concrete tower section 102a and a steel tower section 102b. A hybrid tower section 200 is arranged between the concrete tower section 102a and the steel tower section 102b. A plurality of annular concrete tower sections arranged one above the other generally form the concrete part of the hybrid tower. Also, a plurality of annular steel tower sections arranged one above the other generally form the steel part of the hybrid tower 102.

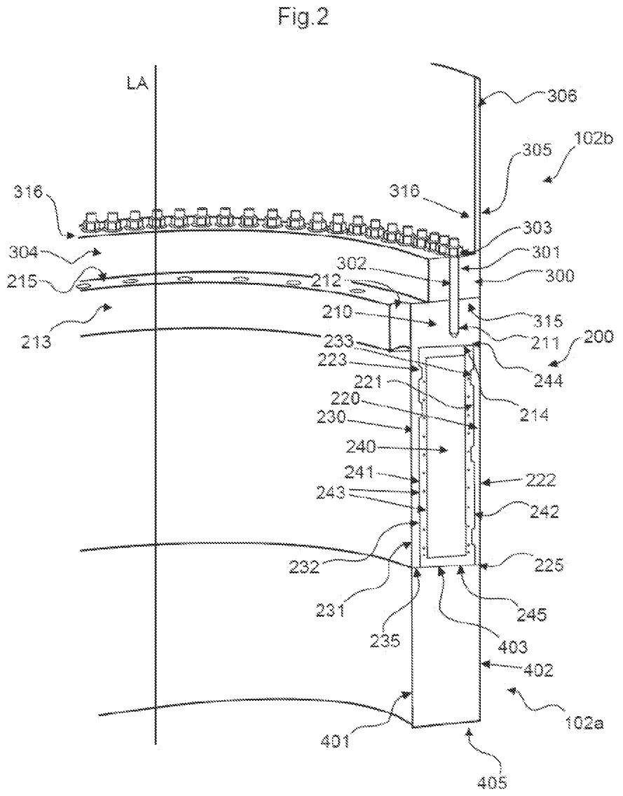

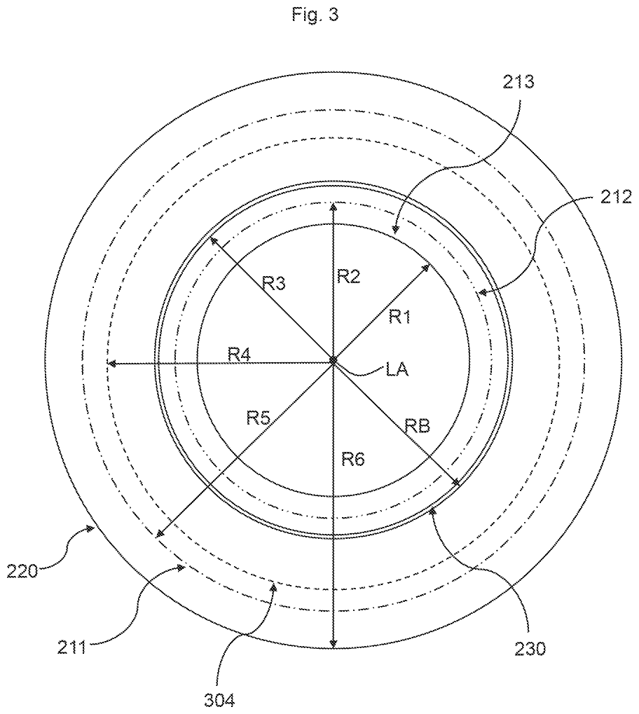

FIGS. 2 and 3 illustrate the hybrid tower section 200 in more detail in an exemplary embodiment. The hybrid tower section 200 comprises a steel flange 210, a steel outer casing 220, a steel inner casing 230 and a concrete core 240. The concrete core 240 has a reinforcement 243.

The hybrid tower section 200 is arranged on a concrete tower section 102a which is arranged therebelow in the operating state and on a steel tower section 102b which is arranged thereabove in the operating state.

The steel flange 210 has a plurality of annularly arranged blind holes 211. The steel flange 210 furthermore has a plurality of annularly arranged passage holes 212. A radius R5 of the annular arrangement of the blind holes 211 is larger than a radius R2 of the annular arrangement of the passage holes 212. Furthermore, a radius R6 of the steel outer casing 220 is larger than the radius R5 of the annular arrangement of the blind holes 211. The radius R3 of the steel inner casing 230 is larger than the radius R2 of the annular arrangement of the passage holes 212 and smaller than the radius R5 of the annular arrangement of the blind holes 211. The radius R4 of a radially inner side 304 of the flange section 300 of the steel tower section 102b is smaller than the radius R5 of the plurality of annularly arranged blind holes 211 in the steel flange 210 of the hybrid tower section and greater than the radius R3 of the steel inner casing 230, the radius R2 of the annular arrangement of passage holes 212 and the radius R1 of the radially inner side 213 of the steel flange 210.

The radii indicated here are in particular with respect to a longitudinal axis LA of the hybrid tower.

The radii indications in FIG. 3 are illustrated schematically. The size ratios of a real hybrid tower of a wind power installation can differ significantly in comparison therewith. Rather, FIG. 3 serves to clarify the principle. The radii described here relate in particular to a central radius of the in each case indicated element.

As can be seen in particular in FIG. 2, in an operating state of the hybrid tower, a lower side 245 of the concrete core 240 directly adjoins an upper side 403 of the concrete tower section 102a. In this case, use can be made of the advantageous coefficient of friction for concrete on concrete. Preferably, that side 245 of the concrete core 240 which is at the bottom in the operating state is aligned with that axial end 225 of the steel outer casing 220 which is at the bottom in the operating state and with that axial end 235 of the steel inner casing 230 which is at the bottom in the operating state. The concrete core 240 adjoins the steel flange 210, the steel outer casing 220 and the steel inner casing 230. In particular, a side 244 of the concrete core 240 that is at the top in the operating state adjoins a side 214 of the steel flange 210 that is at the bottom in the operating state. A radially inner side 241 of the concrete core 240 adjoins a radially outer side 232 of the steel inner casing 230. A radially outer side 242 of the concrete core 240 adjoins a radially inner side 221 of the steel outer casing 220.

A radially outer side 222 of the steel outer casing 220 preferably forms an outer wall of the hybrid tower and is furthermore preferably configured so as to be aligned with a radially outer side 305 of the flange section 300 of the steel tower section 102b, in particular of a steel casing 306 of the steel tower section 102b, and with a radially outer side 402 of the concrete tower section 102a. Furthermore, it is preferably the case that, in the operating state, a radially inner side 231 of the steel inner casing 230 is formed so as to be aligned with a radially inner side 401 of the concrete tower section 102a.

A side 315 of the flange section 300 of the steel tower section 102b that is at the bottom in the operating state preferably bears on a side 215 of the steel flange 210 that is at the top in the operating state.

The flange section 300 of the steel tower section 102b has a plurality of annularly arranged passage holes 301, which is preferably arranged in alignment with the plurality of the annularly arranged blind holes 211 in the steel flange 210 of the hybrid tower section 200. Fastening elements 302, for example in the form of threaded bolts, may preferably be arranged in the passage holes 301 in the flange section 300 of the steel tower section 102b and the blind holes 211 in the steel flange 210 of the hybrid tower section 200 and be fastened by nuts 303 on that side 316 of the flange section 300 of the steel tower section 102b which is at the top in the operating state. In this way, a fastening between the steel tower section 102b and the hybrid tower section 200 can be produced.

The plurality of annularly arranged passage holes 212 in the steel flange 210 of the hybrid tower section 200 serves in particular for receiving external tensioning members (not illustrated) that run in an interior of the hybrid tower and that prestress the concrete tower section 102a between the hybrid tower section 200 and a foundation of the hybrid tower. This results in build-up of a pressure at the abutment connection between that side 245 of the concrete core which is at the bottom in the operating state and a side 403 of the concrete tower section 102a that is at the top in the operating state.

Projections in the form of shear cleats 223 are formed on the radially inner side 221 of the steel outer casing 220. Furthermore, projections in the form of shear cleats 233 are formed on the radially outer side 232 of the steel inner casing 230. Consequently, in a cross section orthogonal to the ring direction or parallel to the longitudinal axis LA, a boundary line between the concrete core 240 and, respectively, the steel outer casing 220 and the steel inner casing 230 is of tooth cut-type form, and a shear-resistant toothing is realized between the concrete core 240 and the steel outer casing and the steel inner casing 230.

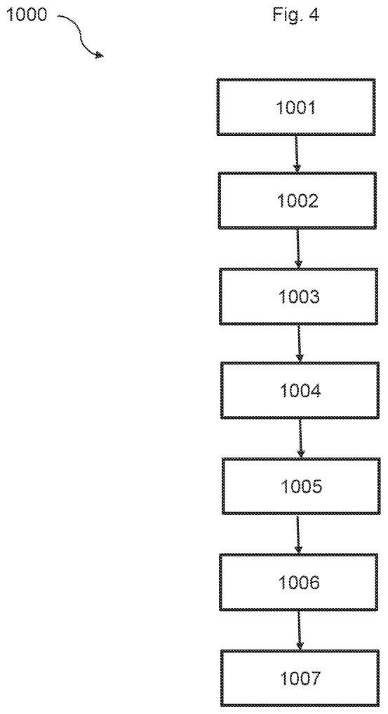

In the method 1000 illustrated in FIG. 4 for producing a hybrid tower section, the following steps are carried out: providing 1001 a steel flange having a plurality of annularly arranged blind holes and having a plurality of annularly arranged passage holes, providing 1002 a steel outer casing, providing 1003 a steel inner casing 230 and arranging it in such a way that the steel inner casing projects upward from that side 214 of the steel flange 210 which is at the bottom in the operating state of the hybrid tower, welding 1004 the steel outer casing 220 and/or the steel inner casing 230 to the steel flange 210.

Further steps are preferably as follows: arranging 1005 the steel flange and the steel outer casing 220 in such a way that a side of the steel flange 210 that is at the bottom in the operating state of the hybrid tower faces upward and the steel outer casing projects upward from that side of the steel flange which is at the bottom in the operating state of a hybrid tower; introducing 1006 reinforcement 243 prior to making 1007 the concrete core 240, making 1007 the concrete core using the steel outer casing and the steel inner casing 230 as a formwork, in particular as a permanent formwork. In this way, the concrete core 240 directly adjoins the steel flange 210 and the steel outer casing 220 and the steel inner casing 230.

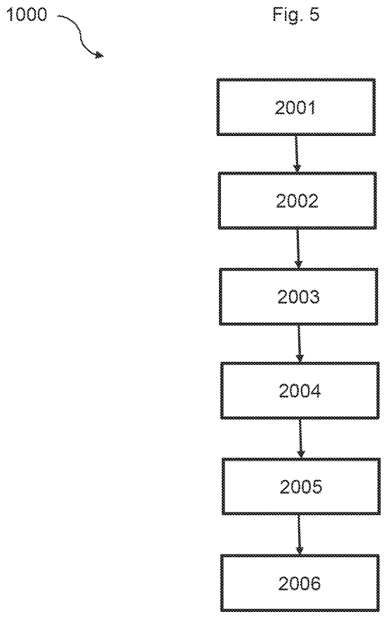

Finally, the method 2000 for producing a hybrid tower for a wind power installation as per FIG. 5 comprises the steps of providing 2001 at least one concrete tower section 102a, arranging 2002 a hybrid tower section 200 as described above on the concrete tower section 102a, arranging 2003 a steel tower section 102b on the hybrid tower section 200, fastening 2004 the steel tower section to the hybrid tower section by means of the plurality of annularly arranged blind holes 211 and preferably the plurality of annularly arranged passage holes 301 in the flange section 300 of the steel tower section 102b and by means of fastening elements 302 and nuts 303, fastening 2005 tensioning members at the plurality of annularly arranged passage holes 212 and preferably tensioning the tensioning members.

With the hybrid tower section described here, there is provided a cost-effective and efficient possibility for reliably connecting the concrete tower section to the steel tower section in a hybrid tower and at the same time saving weight and costs. The shear-resistant toothing via projections in the form of shear cleats on those sides of the steel inner casing and the steel outer casing which face one another with the concrete core, which lacks the intermediate space between the steel outer casing and the steel inner casing, results in an efficient transmission of force.

### REFERENCE SIGNS

1 Wind power installation
102 Hybrid tower
102a Concrete tower section
102b Steel tower section
200 Hybrid tower section
210 Steel flange
211 Blind holes
212 Passage holes
213 Radially inner side of the steel flange
214 Side of the steel flange at the bottom in the operating state
215 Side of the steel flange at the top in the operating state
220 Steel outer casing
221 Radially inner side of the steel outer casing
222 Radially outer side of the steel outer casing
223 Shear cleats on the radially inner side of the steel outer casing
225 Axial end of the steel outer casing at the bottom in the operating state
230 Steel inner casing
231 Radially inner side of the steel inner casing
232 Radially outer side of the steel inner casing
233 Shear cleats on the radially outer side of the steel inner casing
235 Axial end of the steel inner casing at the bottom in the operating state
240 Concrete core
241 Radially inner side of the concrete core
242 Radially outer side of the concrete core
243 Reinforcement
244 Side of the concrete core at the top in the operating state
245 Side of the concrete core at the bottom in the operating state
300 Flange section of the steel tower section
301 Passage holes in the flange section of the steel tower section
302 Fastening elements
303 Nuts
304 Radially inner side of the flange section of the steel tower section
305 Radially outer side of the flange section of the steel tower section
306 Steel casing of the steel tower section
315 Side of the flange section of the steel tower section at the bottom in the operating state
316 Side of the flange section of the steel tower section at the top in the operating state
401 Radially inner side of the concrete tower section
402 Radially outer side of the concrete tower section
403 Side of the concrete tower section at the top in the operating state
405 Side of the concrete tower section at the bottom in the operating state
1000 Method for producing a hybrid tower section
1001 Providing a steel flange
1002 Providing a steel outer casing
1003 Providing a steel inner casing
1004 Welding the steel outer casing and the steel inner casing to the steel flange
1005 Arranging the steel flange and the steel outer casing
1006 Introducing reinforcement
1007 Making the concrete core
2000 Method for producing a hybrid tower for a wind power installation
2001 Providing at least one concrete tower section
2002 Arranging a hybrid tower section on the concrete tower section
2003 Arranging a steel tower section on the hybrid tower section
2004 Fastening the steel tower section to the hybrid tower section
2005 Fastening tensioning members at the plurality of annularly arranged passage holes
2006 Tensioning the tensioning members
LA Longitudinal axis
R1 Radius of the radially inner side of the steel flange
R2 Radius of the annular arrangement of the passage holes
R3 Radius of the steel inner casing
R4 Radius of the radially inner side of the flange section of the steel tower section
R5 Radius of the annular arrangement of the blind holes
R6 Radius of the steel outer casing
RB Radius of the radially inner side of the concrete core

1. A hybrid tower section for arrangement between a concrete tower section and a steel tower section of a hybrid tower for a wind power installation, the hybrid tower section comprising:
a steel flange having a plurality of annularly arranged blind holes and having a plurality of annularly arranged through passage holes,
a steel outer casing, and
a concrete core,
wherein an annular arrangement of the blind holes has a larger radius than an annular arrangement of the through passage holes,
wherein the steel outer casing has a larger radius than the annular arrangement of the blind holes,
wherein the concrete core adjoins the steel flange and the steel outer casing, and a radially inner side of the concrete core has a larger radius than the annular arrangement of the through passage holes.

2. The hybrid tower section as claimed in claim 1 comprising a steel inner casing having a radius that is larger than a radius of the annular arrangement of the through passage holes and smaller than the radius of the annular arrangement of the blind holes.

3. The hybrid tower section as claimed in claim 1 wherein at least one of a radially inner side of the steel outer casing or a radially outer side of the steel inner casing has a contoured surface, one or more projections, one or more depressions, and/or one or more shear cleats.

4. The hybrid tower section as claimed in claim 1 wherein at least one of the steel outer casing or the steel inner casing and the concrete core have an axial height that is larger than an axial height of the steel flange.

5. The hybrid tower section as claimed in claim 4,
wherein the concrete core directly adjoins the radially inner side of the steel outer casing, and/or
wherein the concrete core directly adjoins the radially outer side of the steel inner casing, and/or
wherein the concrete core directly adjoins a side of the steel flange that is at the bottom in the operating state of the hybrid tower, and/or
wherein the concrete core comprises reinforcement, and/or
wherein the concrete core terminates in alignment with at least one of an axial end of the steel outer casing or in alignment with an axial end of the steel inner casing.

6. The hybrid tower section as claimed in claim 2 wherein the concrete core substantially fills a space between the steel outer casing and the steel inner casing.

7. The hybrid tower section as claimed in claim 6, wherein:
at least one of the steel outer casing or the steel inner casing are formed in one piece with the steel flange, or
wherein at least one of the steel outer casing or the steel inner casing are welded to the steel flange.

8. A hybrid tower for a wind power installation, comprising:
at least one concrete tower section and at least one steel tower section, wherein the hybrid tower section as claimed in claim 1 is arranged between the at least one concrete tower section and the at least one steel tower section.

9. A wind power installation comprising:
the hybrid tower section as claimed in claim 8.

10. A method for producing a hybrid tower section for arrangement between a concrete tower section and a steel tower section of a hybrid tower for a wind power installation, the method comprising:
arranging a steel flange and a steel outer casing in such a way that a side of the steel flange that is at a bottom in an operating state of a hybrid tower faces upward and the steel outer casing projects upward from that side of the steel flange which is at the bottom in the operating state of a hybrid tower, wherein the steel flange has a plurality of annularly arranged blind holes and a plurality of annularly arranged through passage holes, wherein the steel outer casing has a larger radius than an annular arrangement of the plurality of annularly arranged blind holes, wherein the annular arrangement of the plurality of annularly arranged blind holes has a larger radius than an annular arrangement of the plurality of annularly arranged through passage holes, and
making the concrete core using the steel outer casing as a formwork in such a way that the concrete core adjoins the steel flange and the steel outer casing and a radially inner side of the concrete core has a larger radius than the annular arrangement of the through passage holes.

11. The method as claimed in claim 10, further comprising:
arranging the steel inner casing in such a way that the steel inner casing projects upward from that side of the steel flange which is at the bottom in the operating state of a hybrid tower, and/or
welding at least one of the steel outer casing or the steel inner casing to the steel flange, and/or
introducing reinforcement prior to making the concrete core, and/or
wherein making the concrete core comprises using the steel inner casing as a formwork.

12. A method for producing a hybrid tower for a wind power installation, the method comprising:
arranging hybrid tower section as claimed in claim 1 on a concrete tower section, and
arranging a steel tower section on the hybrid tower section.

13. The method as claimed in claim 12, further comprising:
fastening the steel tower section to the hybrid tower section by the plurality of annularly arranged blind holes, and/or
fastening tensioning members at the plurality of annularly arranged through passage holes.

14. The method as claimed in claim 13 further comprising tensioning the tensioning members.

15. The hybrid tower section as claimed in claim 4, wherein at least one of the steel outer casing or the steel inner casing and the concrete core have an axial height of 1 to 2 meters.

16. The hybrid tower section as claimed in claim 15, wherein at least one of the steel outer casing or the steel inner casing and the concrete core have a radial thickness of 1 to 20 centimeters.
